(19) United States
(12) Patent Application Publication
(10) Pub. No.: US 2015/0319121 A1
(43) Pub. Date: Nov. 5, 2015

(54) COMMUNICATING A MESSAGE TO USERS IN A GEOGRAPHIC AREA

(71) Applicant: Ashwini Iyer, Saratoga, CA (US)

(72) Inventor: Ashwini Iyer, Saratoga, CA (US)

(21) Appl. No.: 14/704,436

(22) Filed: May 5, 2015

Related U.S. Application Data
(60) Provisional application No. 61/988,439, filed on May 5, 2014.

(51) Int. Cl. H04L 12/58; H04L 29/08

(52) U.S. Cl. CPC H04L 51/20; H04L 67/22

(57) ABSTRACT

In a method for communicating a message to users in a geographic area, a request for emotion data for users of an emotion tracking application within the geographic area is received, the request defining the geographic area and received at a user interface of a client device, the emotion tracking application for receiving the emotion data of the users and for transmitting the emotion data of the users to a remote emotion data server, wherein the emotion data is an indication of a mood of the user at a time of entry of the emotion data. The request for the emotion data for users of the emotion tracking application within the geographic area is transmitted to the remote emotion data server. The emotion data for users of the emotion tracking application within the geographic area is received from the remote emotion data server. A map including the emotion data for users of the emotion tracking application within the geographic area is rendered at the user interface of the client device.

### CROSS-REFERENCE TO RELATED U.S. APPLICATIONS

This application claims priority to U.S. Provisional Patent Application No. 61/988,439, filed May 5, 2014, entitled “Tracking Moods of a User,” by Ashwini Iyer, and having Attorney Docket No. IYER-001.PRO, the disclosure of which is hereby incorporated herein by reference in its entirety.

### BACKGROUND

As humans become more and more dependent on technology, many believe that there is an observable disconnect between individuals. In the opinion of some, individuals often are more isolated as a result of this reliance on technology. Moreover, as there is increasing concern of tracking and identifying individuals using client devices, users may be less likely to connect via technology where their identify may be revealed.

### BRIEF DESCRIPTION OF THE DRAWINGS

The accompanying drawings, which are incorporated in and form a part of this specification, illustrate various embodiments and, together with the Description of Embodiments, serve to explain principles discussed below. The drawings referred to in this brief description of the drawings should not be understood as being drawn to scale unless specifically noted.

FIG. 1 is an example block diagram of a system in which emotion data can be stored and managed, in accordance with various embodiments.

FIG. 2 illustrates an example graph of historical mood data viewable through a user interface, in accordance with an embodiment.

FIG. 3 illustrates an example map of a geographic area showing emotion data viewable through a user interface, in accordance with an embodiment.

FIG. 4 is an example data flow diagram illustrating tracking of emotion data, in accordance with various embodiments.

FIG. 5 is an example data flow diagram illustrating receiving emotion data of others, in accordance with various embodiments.

FIG. 6 is a flow diagram of a method of tracking emotion data, in accordance with various embodiments.

FIG. 7 is a flow diagram of a method of receiving emotion data of others, in accordance with various embodiments.

### DESCRIPTION OF EMBODIMENTS

Reference will now be made in detail to various embodiments, examples of which are illustrated in the accompanying drawings. While various embodiments are discussed herein, it will be understood that they are not intended to be limiting. On the contrary, the presented embodiments are intended to cover alternatives, modifications and equivalents, which may be included within the spirit and scope the various embodiments as defined by the appended claims. Furthermore, in this Description of Embodiments, numerous specific details are set forth in order to provide a thorough understanding. However, embodiments may be practiced without one or more of these specific details. In other instances, well known methods, procedures, components, and circuits have not been described in detail as not to unnecessarily obscure aspects of the described embodiments.

### Notation and Nomenclature

Unless specifically stated otherwise as apparent from the following discussions, it is appreciated that throughout the present Description of Embodiments, discussions utilizing terms such as “receiving,” “associating,” “transmitting,” “rendering,” or the like, often refer to the actions and processes of an electronic computing device or system, such as a smartphone, tablet, or server, among others. In some embodiments, the electronic computing device/system may be a portion of a distributed computing system. The electronic computing device/system transmits, receives, stores, manipulates and/or transforms signals represented as physical (electrical) quantities within the circuits, components, logic, and the like, of the electronic computing device/system into other signals similarly represented as physical electrical quantities within the electronic computing device/system or within or transmitted to other electronic computing devices/systems.

### Overview of Discussion

In accordance with various described embodiments, methods and systems are described herein for tracking the moods of a user. In other embodiments, methods and systems are described herein for allowing a user to identify the moods of users within a geographic location. In various embodiments, a user may transmit communications to users within the geographic area. It should be appreciated that, in accordance with the various described embodiments, communications to and from users may be anonymous, such that the communications are transmitted without personally identifiable information.

In various embodiments, the described methods and systems allow a user to track their own emotional moods using a client device. For example, if a user feels upset, the user would input that they are upset into the user interface. In various embodiments, these moods are transmitted to a server, along with location and time information. It should be appreciated that many users consider information related to their emotional moods highly personal, and thus may have privacy concerns regarding such personal information. While the emotional moods may be transmitted to the server with personally identifiable information, it should be appreciated that in various embodiments, the mood information is transmitted without personally identifiable information.

Various embodiments also provide methods and systems for identifying and uplifting the emotional moods of others. As presented above, the moods are stored at the server and are accessible by users. In various embodiments, a user would request emotional mood data for users within a geographic area. For example, a user would select a particular geographic area (e.g., a city, a zip code, a radius around a selected point, etc.) at a user interface of the client device. Moreover, it should be appreciated that the user can select a particular date and/or time for which to receive the mood information. The server would return to the user interface a map indicating mood information for the selected geographic area. In this way a user might be able to identify areas that are “happy” or “sad.”

In accordance with various embodiments, the user is provided with the opportunity to attempt to uplift the emotional moods of other users. A user may transmit a message to users within the geographic area. It should be appreciated that the message may take many forms including, without limitation: jokes, pictures, videos, songs, poems, cartoons, cheergrams (described below), etc. For example, a user requests the emotional moods for San Jose, Calif. Upon receiving the map of the emotional moods for San Jose, Calif., the user identifies a particular region within San Jose in which the emotional moods indicate that users within this particular region are sad (e.g., the local high school is having exams). The user might select a message (e.g., an uplifting quote by a famous author) to send to users within the geographic area in an attempt to alleviate their sadness. Users within the selected geographic area would receive the message over a user interface of their client devices.

### Example System for Tracking Moods of a User

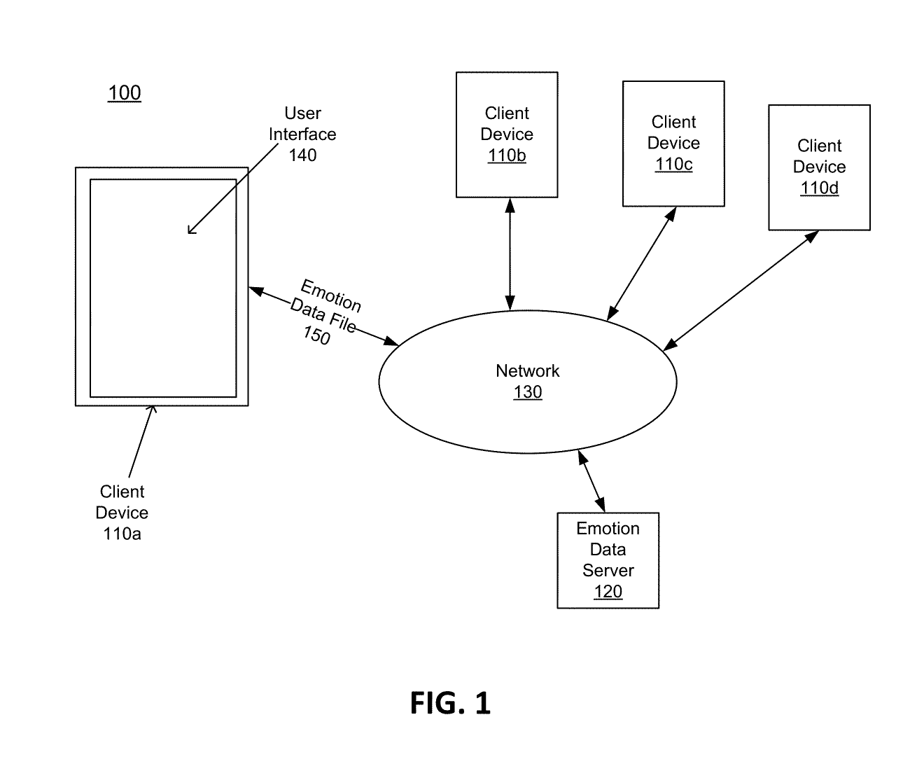

FIG. 1 is an example block diagram of a system 100 in which emotion data can be stored and managed, in accordance with embodiments. System 100 comprises a plurality of client devices 110a-d and emotion data server 120 communicatively coupled over network 130. It should be appreciated that system 100 may comprise any number of client device 110a-d and emotion data servers 120, and that the number of components shown in FIG. 1 is for illustrative purposes only. Moreover, it should be appreciated that emotion data server 120 may be comprised of a plurality of components distributed across network 130.

For purposes of the instant description of embodiments, one of client devices 110a-d is referred to as client device 110. In one embodiment, client device 110 is a portable client device, such as a smartphone or a tablet. However, it should be appreciated that client device 110 may be any type of client device that is capable of presenting a user interface and for communicating data between emotion data server 120 over network 130. Moreover, it should be appreciated that the described components of client device 110 may be implemented as hardware, software, firmware, or any combination thereof.

In one embodiment, client device 110 comprises components for presenting a user interface 140. In one embodiment, user interface 140 is a touch screen configured for rendering images and for receiving input from a user. In another embodiment, user interface 140 comprises a display screen and a keyboard. It should be appreciated that client device 110 can comprise any user interface 140 for presenting images and receiving input from a user, and is not intended to be limited to the described embodiments.

Emotion data server 120 is configured to receive and store emotion data transmitted from client devices 110a-d over network 130. In various embodiments described herein, emotion data server 120 is configured to respond to requests for data received from client devices 110a-d. Emotion data server 120 comprises processing capabilities for modifying data stored therein responsive to a request from one of client devices 110a-d.

For purposes of the instant description of embodiments, it should be appreciated that network 130 may be any network configured for communicating data between client devices 110a-d and emotion data server 120. For example, any of client devices 110a-d may be communicatively coupled to a wireless network of network 130. It should be appreciated that the wireless network may be a cellular network, a local area network (LAN), or other type of wireless network. The wireless network may be communicatively coupled to a wired network which is communicatively coupled to emotion data server 120. It should be appreciated that network 130 may comprise any number of nodes between client devices 110a-d and emotion data server 120.

In one embodiment, client device 110 has stored therein computer-readable instructions for executing a method of emotion tracking. For example, a software program or application may be executed on client device 110 for emotion tracking. This software program or application may be executed responsive to a user interaction with the user interface of client device 110, and would be initiated according to the operating system of client device 110.

At initialization of the emotion tracking system (e.g., at setup), in one embodiment, client device 110 renders a display prompting a user to enter various information, such as date of birth (e.g., for determining the user's age or age range) and gender. As presented above, in various embodiments described herein, the information requested is of the nature that privacy of the user is preserved. In other embodiments, while personally identifiable information may be requested of the user, that personally identifiable information is not transmitted to emotion data server 120, and may only be stored locally on client device 110. For example, while a date of birth might be requested at initialization, client device 110 might only transmit an age or age range of the user to emotion data server 120.

After initialization of the emotion tracking system, during operation, user interface 140 is configured to receive emotion data from the user. Emotion data is an indication of the mood of the user at the time of entry of the emotion data. It should be appreciated that the emotion data can be entered in many different forms. For example, in one embodiment, the emotion data is selected from a list of words that describe various emotions (e.g., happy, sad, worried, distraught, etc.) In another embodiment, the emotion data is selected from a color related to various emotions (e.g., sad equates to blue, happy equates to red, etc.) In another embodiment, the emotion data is selected from a listing of pictorial representations of various moods (e.g., emoticons). In another embodiment, the emotion data is selected from a number scale (e.g., 1 through 10, where 1 is saddest and 10 is happiest). In another embodiment, the emotion data may be typed input (e.g., a word, a number value, an emoticon, etc.) In various embodiments, the emotion data might be selected from a drop down menu. In another embodiment, the user interface may display a color wheel, and the emotion data is selected by a user interaction with the color wheel. It should be appreciated that embodiments of the present invention allow for many different forms of emotion data input, and is not intended to be limited to the described embodiments.

In one embodiment, the emotion data received at the user interface is mapped to a value. For instance, where the emotion data is selected from a list of words, each word has an associated value. For example, the word “ecstatic” might be associated with the value 10 and the word “devastated” might be associated with the value 1. It should be appreciated that any value convention might be used (e.g., −5 through 5, 0 through 100, etc.) It should be appreciated that different users might select different ways of entering emotion data, and mapping the selected emotion data to a value allows for normalizing the input over a number of users. In various embodiments, users may also be able to submit proposed moods for addition to the selection, subject to the approval of a system administrator.

In one embodiment, the emotion tracking system also allows a user to submit a journal entry associated with the emotion data entered by the user. In other words, a user may enter text using the user interface related to the emotion data that is entered. For example, if the user wishes to expound on the reason for selecting a particular emotion data input, the user would submit a journal entry (e.g., a diary entry). This journal entry is stored locally and accessibly to the user via the user interface.

Client device 110 associates the emotion data with a time of entry of the emotion data and a location of the client device 110 at the time of the entry of the emotion data. That is, an instance of emotion data is stored along with an associated time of entry and location of entry. In one embodiment, the time of entry is determined using a clock of client device 110. In one embodiment, the location of the client device at the time of entry of the emotion data is determined according to a global positioning system (GPS) receiver of client device 110. In another embodiment, the location of entry is determined according to an Internet protocol (IP) address of client device 110. In another embodiment, the location of entry is determined using information from a cell tower through which client device 110 is communicating. It should be appreciated that the location of entry can be determined other ways, and is not intended to be limited to the described embodiments.

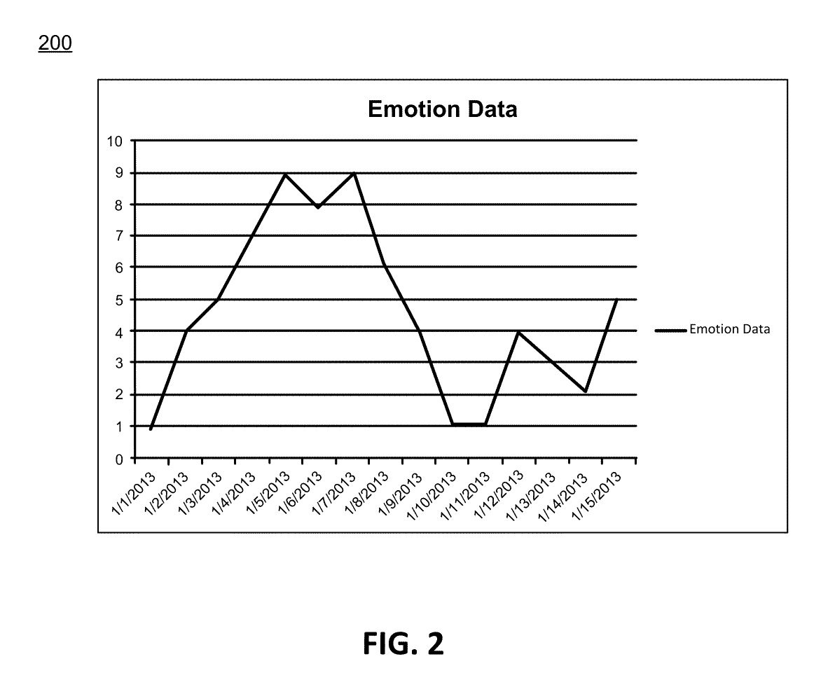

In one embodiment, historical moods are accessible through the user interface and may be displayed (e.g., in a graph with the mood value on the Y-axis and the date and/or time on the X-axis). FIG. 2 illustrates an example graph of historical mood data viewable through a user interface, in accordance with an embodiment. As shown in FIG. 2, the mood value (ranging from 1 through 10) on the Y-axis is shown over a given date range (Jan. 1, 2013, through Jan. 15, 2013) on the X-axis. This allows a user to track their own emotional moods over a given time period.

With returning reference to FIG. 1, after emotion data is received at client device 110a, the emotion data, along with the associated time of entry and location of entry, is transmitted to emotion data server 120 over network 130. In one embodiment, as shown in FIG. 1, emotion data file 150 is transmitted from client device 110a to emotion data server 120 over network 130, where emotion data file 150 includes the emotion data, along with the associated time of entry and location of entry. In one embodiment, emotion data file 150 also includes information related to the age of the user (e.g., birthdate, age, age range). In one embodiment, emotion data file 150 also includes the gender of the user. In one embodiment, the emotion data, the time of entry of the emotion data, and the location of the client device at the time of entry of the emotion data is communicated to the remote emotion data server without transmitting personally identifiable information of the user. Emotion data server 120 receives and stores emotion data transmitted from client devices 110a-d.

In one embodiment, client device 110 receives a request for emotion data for other users within a geographic area. In one embodiment, the request is received from a user interacting with the user interface. In one embodiment, the requested emotion data is of a particular type of emotion data (e.g., only happy emotion data or only moderate to sad emotion data.) In one embodiment, the request also includes a time (or time range) of the emotion data for the requested geographic area. In one embodiment, if no time is indicated, the emotion data will be requested for the current time (or a range from the current time to an earlier time, e.g., the previous hour). In one embodiment, the request also includes a selected gender. In one embodiment, the request also includes a selected age or age range. In various embodiments, and without limitation, the geographic area may be indicated by a zip code, a city, a state, a county, an address plus a radial distance, a latitude and longitude range, a latitude and longitude plus a radial distance, a landmark plus a radial distance, or a manual input onto a displayed map. It should be appreciated that the geographic area may be input in other ways, and is not intended to be limited to the described embodiments. In one embodiment, geographic areas might be bookmarked by a user.

It should be appreciated that in various embodiments, where privacy concerns are taken into consideration, the geographic area requested is limited to a certain granularity. For instance, providing emotion data for a small geographic area might risk exposing a particular user. Therefore, administrators of the described system may define minimum sizes for requested geographic areas. It should also be appreciated that these minimum sizes might vary on location. For instance, a densely populated urban area might be able to support a smaller geographic area while still preserving anonymity of the users, while a rural area might require a larger minimum size of the geographic area to preserve anonymity of the users.

Client device 110 transmits the request for emotion data for other users with a geographic area to emotion data server 120 over network 130. In one embodiment, emotion data server 120 will verify that the geographic area satisfies the minimum size requirements for the particular location, to preserve anonymity. Emotion data server 120 identifies emotion data satisfying the request. In one embodiment, emotion data server 120 processes the data in a manner that ensures that there is sufficient bandwidth to provide the emotion data to client device 110. For instance, if the requested geographic area is the United States of America, there might be too much emotion data to transmit to client device 110. Accordingly, in the instant example, emotion data server 120 will aggregate the emotion data according to the granularity of the geographic location.

Client device 110 receives the requested emotion data for the geographic area from emotion data server 120. In one embodiment, the emotion tracking system provides a map illustrating the emotion data for the geographic area. In one embodiment, the emotion data is indicated on the map as color-coded markers or flags (e.g., red markers indicate happy areas and blue markers indicate sad areas). It should be appreciated that other colors might be used. In another embodiment, the map is shaded different colors according to the emotion data received from emotion data server 120. It should be appreciated that shading the map also serves to protect the anonymity of users by not using markers to indicate specific locations of entry.

In one embodiment, the map rendered at the user interface might be magnified to increase or decrease the geographic area. In one embodiment, to preserve anonymity, the magnification can only be performed to a particular range (e.g., one square mile.

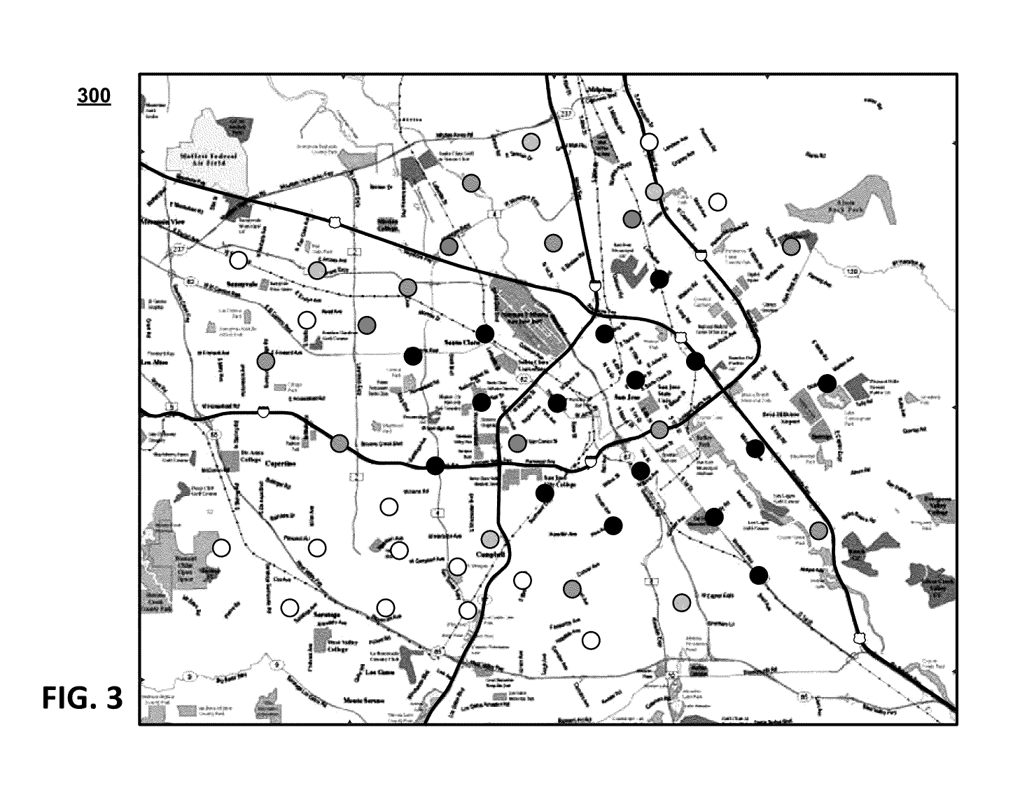

FIG. 3 illustrates an example map 300 of a geographic area showing emotion data viewable through a user interface, in accordance with an embodiment. As illustrated, a number of markers shaded from black to white (with gradient greys) are illustrated over a portion of Santa Clara County, Calif., USA. The darker markers illustrate unhappy moods of users and the lighter makers illustrate happy moods. As described above, it should be appreciated that different colors, markers, shadings, etc., could be used to indicate the emotion data for a geographic area.

Upon viewing a map of emotion data for a geographic area, a user of client device 110 might wish to communicate a message to users within a geographic area. For example, if a user identifies a particularly unhappy location, the user might select to send an uplifting message to client devices within that geographic area. In one embodiment, a user selects a message from those provided in user interface 140. It should be appreciated that the message may take many forms including, without limitation: jokes, pictures, videos, songs, poems, quotations, lyrics, cartoons, cheergrams, etc. For purposes of the instant application, a cheergram is defined as a message having an address, in which the address is a region on the globe. The cheergram message is an inspirational message selected from a preapproved catalog of uplifting quotes.

In accordance with various embodiments, the messages available for sending are prescreened and approved for transmission to users. In one embodiment, only those available for transmission are presented and selectable. In another embodiment, a user may select a message that is not available through user interface 140. In the present embodiment, a new message could be received from the user at user interface 140. In one embodiment, this message might require preapproval (e.g., approval from an administrator) prior to transmission to users within the geographic area.

It should be appreciated that the described system for tracking emotions is intended to by supportive and uplifting to those participating. Therefore, in various embodiments, only approved messages will be sent to users. Moreover, a user may customize those messages to only those that they wish to receive. For example, if a user does not like poetry, the user may block the receipt of messages including poetry.

In one embodiment, client device 110 receives a request to send a message to users within a geographic area, also referred to as an address. It should be appreciated that this geographic area might be different than the geographic area associated with the request for emotion data. For instance, the message geographic area might be a subset of the emotion data geographic area. In one embodiment, the request to send a message is received from a user interacting with the user interface. In one embodiment, the request is to send a message to only a particular type of emotion data (e.g., only happy emotion data or only moderate to sad emotion data.) In one embodiment, the request to send a message also includes a selected gender. In one embodiment, the request to send a message also includes a selected age or age range. In various embodiments, and without limitation, the geographic area may be indicated by a zip code, a city, a state, a county, an address plus a radial distance, a latitude and longitude range, a latitude and longitude plus a radial distance, a landmark plus a radial distance, or a manual input onto a displayed map. It should be appreciated that the geographic area may be input in other ways, and is not intended to be limited to the described embodiments.

It should be appreciated, however, that since anonymity is preserved in various embodiments, the message may not be received by a client device if it has left the geographic area. For example, if a user is in a particular geographic area and enters that they are unhappy, but leaves the geographic are before an uplifting message is sent to the geographic area, the user will not receive the uplifting message.

### Example Flow Diagrams for Tracking Emotion Data

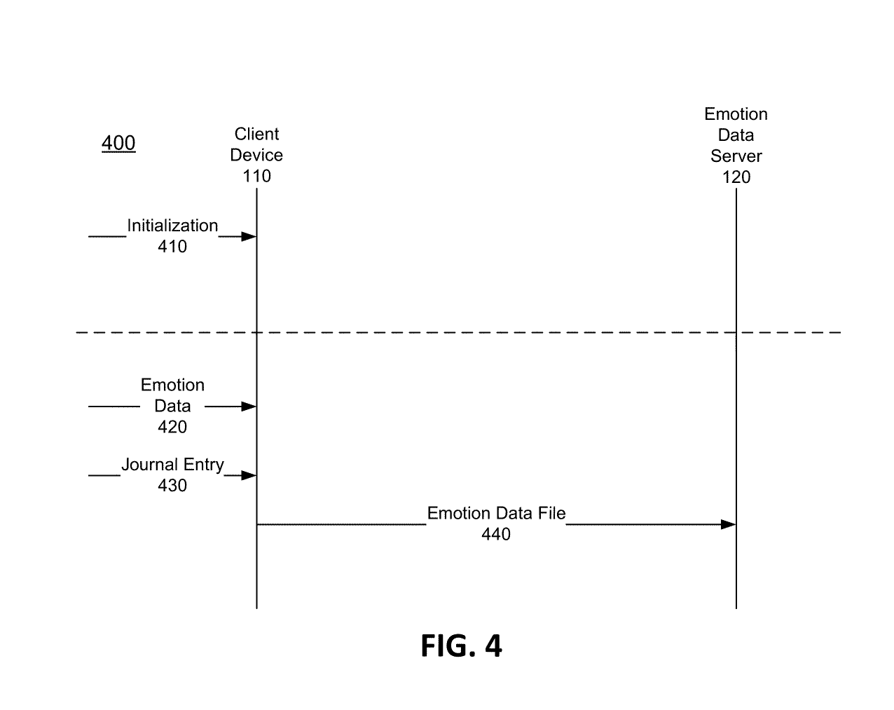

FIG. 4 is an example data flow diagram 400 illustrating tracking of emotion data, in accordance with embodiments. As depicted, client device 110 receives initialization data 410. In one embodiment, initialization data 410 includes information related to the age of the user (e.g., birthdate, age, age range). In one embodiment, initialization data 410 includes the gender of the user. In one embodiment, initialization data includes information identifying which types of messages the user will or will not accept.

Client device 110 is configured to receive emotion data 420. As presented above, emotion data is an indication of the mood of the user at the time of entry of the emotion data. It should be appreciated that the emotion data can be entered in many different forms, e.g., selected from a list of words that describe various emotions, selected from a color related to various emotions, selected from a listing of pictorial representations of various moods (e.g., emoticons), selected from a number scale (e.g., 1 through 10, where 1 is saddest and 10 is happiest), typed input, selected from a drop down menu, selected by a user interaction with a color wheel, etc. It should be appreciated that embodiments of the present invention allow for many different forms of emotion data input, and is not intended to be limited to the described embodiments. Client device 110 stores emotion data 420 with the associated time of entry of emotion data 420 and location at time of entry of emotion data 420. In one embodiment, client device also receives journal entry 430.

Emotion data file 440, including emotion data 420, the associated time of entry of emotion data 420, and the location at time of entry of emotion data 420, is transmitted to emotion data server 120. In one embodiment, emotion data file 440 also includes information related to the age of the user (e.g., birthdate, age, age range). In one embodiment, emotion data file 440 also includes the gender of the user.

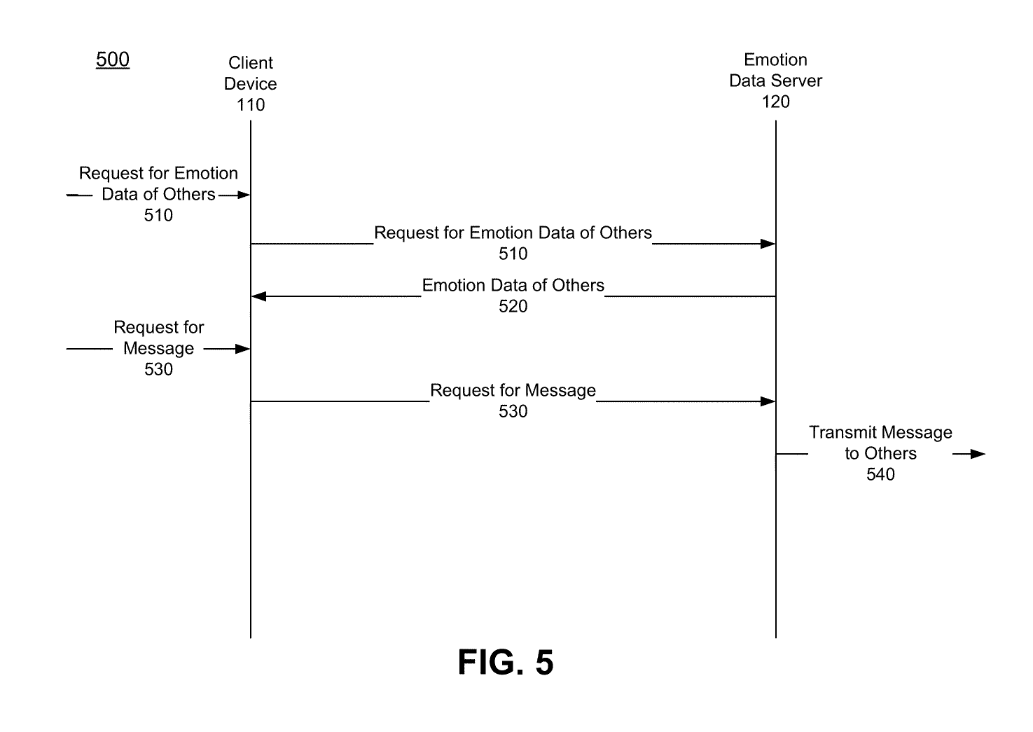

FIG. 5 is an example data flow diagram 500 illustrating receiving emotion data of others, in accordance with embodiments. As depicted, client device 110 receives request 510 for the emotion data of others. Client device 110 transmits request 510 to emotion data server 120. Emotion data server 120 transmits emotion data of others 520 to client device 110. In one embodiment, emotion data of others 520 is used to render a map at the user interface of client device 110 for illustrating emotion data of others.

In one embodiment, client device 110 receives request 530 to send a message to others. Client device 110 transmits request 530 to emotion data server 120. Emotion data server 120 transmits message 540 to others.

### Example Methods of Operation

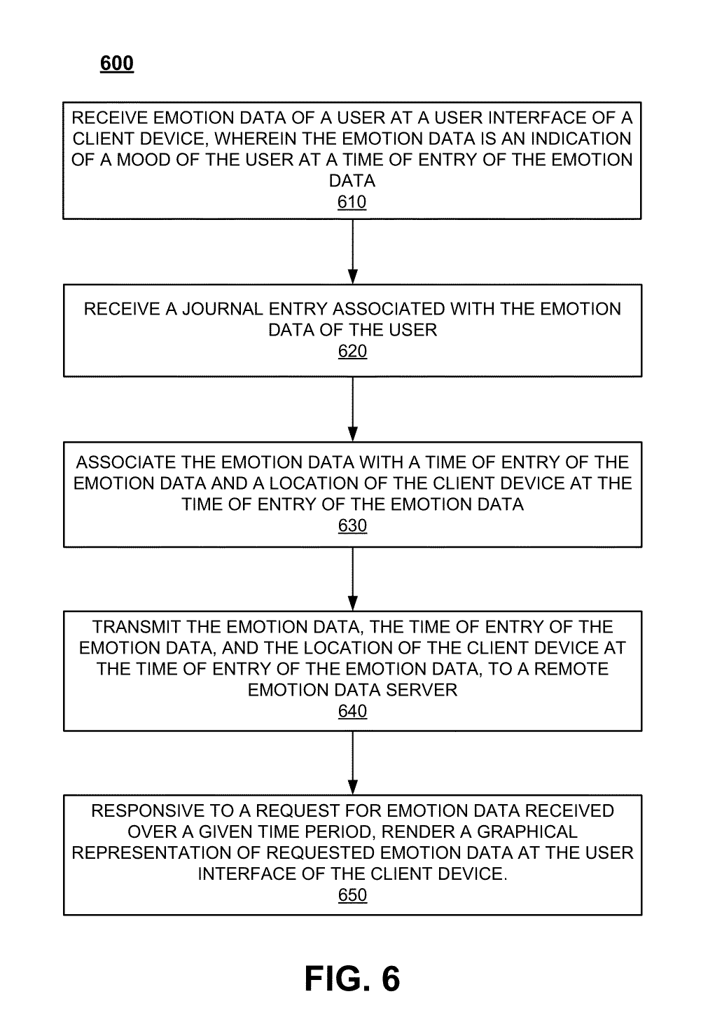

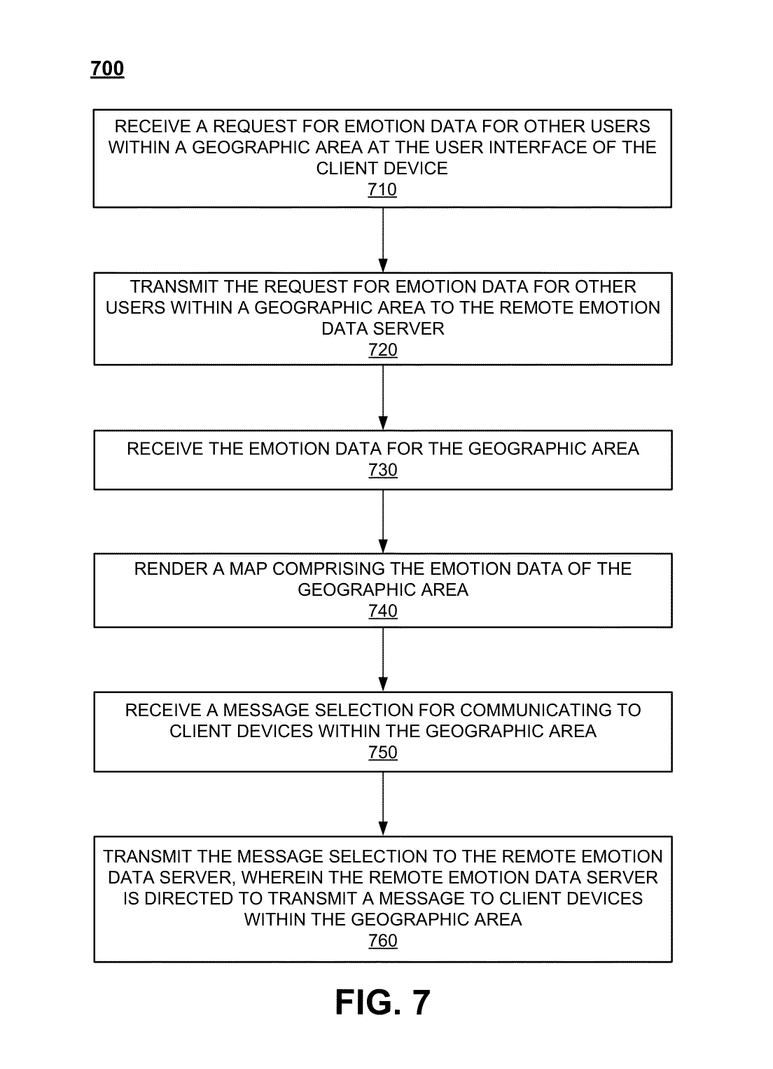

The following discussion sets forth in detail the operation of some example methods of operation of embodiments. With reference to FIGS. 6 and 7, flow diagram 600 and 700 illustrate example procedures used by various embodiments. Flow diagrams 600 and 700 include some procedures that, in various embodiments, are carried out by a processor under the control of computer-readable and computer-executable instructions. In this fashion, procedures described herein and in conjunction with flow diagrams 600 and/or 700 are, or may be, implemented using a computing device, in various embodiments. The computer-readable and computer-executable instructions, e.g., computer readable program code, can reside in any tangible computer readable storage media. Some non-limiting examples of tangible computer readable storage media include random access memory, read only memory, magnetic disks, solid state drives/“disks,” and optical disks, any or all of which may be employed. The computer-readable and computer-executable instructions, which reside on tangible computer readable storage media, are used to control or operate in conjunction with, for example, one or some combination of processors of a computing system. It is appreciated that the processor(s) may be physical or virtual or some combination (it should also be appreciated that a virtual processor is implemented on physical hardware).

Although specific procedures are disclosed in flow diagrams 600 and 700, such procedures are examples. That is, embodiments are well suited to performing various other procedures or variations of the procedures recited in flow diagram 600 and/or 700. Likewise, in some embodiments, the procedures in flow diagrams 600 and/or 700 may be performed in an order different than presented and/or not all of the procedures described in one or more of these flow diagrams may be performed. It is further appreciated that procedures described in flow diagram 600 and/or 700 may be implemented in hardware, or a combination of hardware with firmware and/or software.

FIG. 6 is a flow diagram 600 of a method of tracking emotion data, in accordance with various embodiments. At procedure 610 of flow diagram 600, emotion data of a user is received at a user interface of a client device, wherein the emotion data is an indication of a mood of the user at a time of entry of the emotion data. In one embodiment, as shown at procedure 620, a journal entry associated with the emotion data of the user is received.

At procedure 630, the emotion data is associated with a time of entry of the emotion data and a location of the client device at the time of entry of the emotion data. In one embodiment, the location of the client device at the time of entry of the emotion data is determined according to a global positioning system (GPS) receiver of the client device

At procedure 640, the emotion data, the time of entry of the emotion data, and the location of the client device at the time of entry of the emotion data, are transmitted to a remote emotion data server. In one embodiment, the emotion data, the time of entry of the emotion data, and the location of the client device at the time of entry of the emotion data is communicated to the remote emotion data server without transmitting personally identifiable information of the user. In one embodiment, the emotion data, the time of entry of the emotion data, and the location of the client device at the time of entry of the emotion data are stored within an emotion data file. In one embodiment, the emotion data file further comprises an age of the user. In one embodiment, wherein the emotion data file further comprises a gender of the user.

At procedure 650, responsive to a request for emotion data received over a given time period, a graphical representation of requested emotion data is rendered at the user interface of the client device.

FIG. 7 is a flow diagram 700 of a method of receiving emotion data of others, in accordance with various embodiments. At procedure 710 of flow diagram 700, a request for emotion data for other users within a geographic area is received at the user interface of the client device. At procedure 720, the request for emotion data for other users within a geographic area is transmitted to the remote emotion data server. At procedure 730, the emotion data for the geographic area is received. At procedure 740, a map comprising the emotion data of the geographic area is rendered.

At procedure 750, a message selection for communicating to client devices within the geographic area is received. At procedure 760, the message selection is transmitted to the remote emotion data server, wherein the remote emotion data server is directed to transmit a message to client devices within the geographic area.

Example embodiments of the subject matter are thus described. Although various embodiments of the have been described in a language specific to structural features and/or methodological acts, it is to be understood that the appended claims are not necessarily limited to the specific features or acts described above. Rather, the specific features and acts described above are disclosed as example forms of implementing the claims and their equivalents.

What is claimed is:

1. A computer-implemented method for communicating a message to users in a geographic area, the method comprising:
receiving a request for emotion data for users of an emotion tracking application within the geographic area, the request defining the geographic area and received at a user interface of a client device, the emotion tracking application for receiving the emotion data of the users and for transmitting the emotion data of the users to a remote emotion data server, wherein the emotion data is an indication of a mood of the user at a time of entry of the emotion data;
transmitting the request for the emotion data for users of the emotion tracking application within the geographic area to the remote emotion data server;
receiving the emotion data for users of the emotion tracking application within the geographic area from the remote emotion data server; and
rendering a map comprising the emotion data for users of the emotion tracking application within the geographic area at the user interface of the client device.

2. The computer-implemented method of claim 1, further comprising:
receiving a message selection for communicating to client devices within the geographic area, the message selection received at the user interface of the client device; and
transmitting the message selection to the remote emotion data server, wherein the remote emotion data server is directed to transmit a message to client devices executing the emotion tracking application within the geographic area.

3. The computer-implemented method of claim 1, wherein the emotion data, the time of entry of the emotion data, and a location of the client device at the time of entry of the emotion data are stored within an emotion data file.

4. The computer-implemented method of claim 3, wherein the emotion data file further comprises an age of the user.

5. The computer-implemented method of claim 3, wherein the emotion data file further comprises a gender of the user.

6. The computer-implemented method of claim 3, wherein the location of the client device at the time of entry of the emotion data is determined according to a global positioning system (GPS) receiver of the client device.

7. The computer-implemented method of claim 1, wherein the emotion data for users of the emotion tracking application within the geographic area received at the client device does not comprise personally identifiable information of the users of the emotion tracking application.

8. The computer-implemented method of claim 1, further comprising:
receiving first emotion data of a first user at the user interface of the client device, wherein the first emotion data is an indication of a mood of the first user at a time of entry of the first emotion data;
associating the first emotion data with a time of entry of the first emotion data and a location of the client device at the time of entry of the emotion data; and
transmitting the first emotion data, the time of entry of the first emotion data, and the location of the client device at the time of entry of the first emotion data, to the remote emotion data server.

9. The computer-implemented method of claim 8, further comprising:
receiving a journal entry associated with the first emotion data of the first user at the client device.

10. The computer-implemented method of claim 8, further comprising:
responsive to a request for emotion data of the first user received over a given time period, rendering a graphical representation of requested emotion data of the first user at the user interface of the client device.

11. The computer-implemented method of claim 8, wherein the first emotion data, the time of entry of the first emotion data, and the location of the client device at the time of entry of the first emotion data is communicated to the remote emotion data server without transmitting personally identifiable information of the user.

12. A non-transitory computer readable storage medium comprising instructions stored thereon which, when executed, cause a computer system to perform method for communicating a message to users in a geographic area, said method comprising:
receiving a request for emotion data for users of an emotion tracking application within the geographic area, the request defining the geographic area and received at a user interface of a client device, the emotion tracking application for receiving the emotion data of the users and for transmitting the emotion data of the users to a remote emotion data server, wherein the emotion data is an indication of a mood of the user at a time of entry of the emotion data;
transmitting the request for the emotion data for users of the emotion tracking application within the geographic area to the remote emotion data server;
receiving the emotion data for users of the emotion tracking application within the geographic area from the remote emotion data server;
rendering a map comprising the emotion data for users of the emotion tracking application within the geographic area at the user interface of the client device;
receiving a message selection for communicating to client devices within the geographic area, the message selection received at the user interface of the client device; and
transmitting the message selection to the remote emotion data server, wherein the remote emotion data server is directed to transmit a message to client devices executing the emotion tracking application within the geographic area.

13. The non-transitory computer readable storage medium of claim 12, wherein the emotion data, the time of entry of the emotion data, and a location of the client device at the time of entry of the emotion data are stored within an emotion data file.

14. The non-transitory computer readable storage medium of claim 13, wherein the emotion data file further comprises an age of the user.

15. The non-transitory computer readable storage medium of claim 13, wherein the emotion data file further comprises a gender of the user.

16. The non-transitory computer readable storage medium of claim 13, wherein the location of the client device at the time of entry of the emotion data is determined according to a global positioning system (GPS) receiver of the client device.

17. The non-transitory computer readable storage medium of claim 12, wherein the emotion data for users of the emotion tracking application within the geographic area received at the client device does not comprise personally identifiable information of the users of the emotion tracking application.

18. A non-transitory computer readable storage medium comprising instructions stored thereon which, when executed, cause a computer system to perform method for communicating a message to users in a geographic area, said method comprising:
receiving emotion data of a user of an emotion tracking application at a user interface of a client device, wherein the emotion data is an indication of a mood of the user at a time of entry of the emotion data;
associating the emotion data with a time of entry of the emotion data and a location of the client device at the time of entry of the emotion data, wherein the emotion data, the time of entry of the emotion data, and a location of the client device at the time of entry of the emotion data are stored within an emotion data file;
transmitting the emotion data, the time of entry of the emotion data, and the location of the client device at the time of entry of the emotion data, to a remote emotion data server;
receiving a request for emotion data for other users of the emotion tracking application within the geographic area, the request defining the geographic area and received at the user interface of the client device;
transmitting the request for the emotion data for other users of the emotion tracking application within the geographic area to the remote emotion data server;
receiving the emotion data for other users of the emotion tracking application within the geographic area from the remote emotion data server;
rendering a map comprising the emotion data for other users of the emotion tracking application within the geographic area at the user interface of the client device;
receiving a message selection for communicating to client devices within the geographic area, the message selection received at the user interface of the client device; and
transmitting the message selection to the remote emotion data server, wherein the remote emotion data server is directed to transmit a message to client devices executing the emotion tracking application within the geographic area.

19. The non-transitory computer readable storage medium of claim 18, wherein the emotion data file further comprises an age of the user and a gender of the user, and wherein the location of the client device at the time of entry of the emotion data is determined according to a global positioning system (GPS) receiver of the client device.

20. The non-transitory computer readable storage medium of claim 18, wherein the emotion data for other users of the emotion tracking application within the geographic area received at the client device does not comprise personally identifiable information of the other users of the emotion tracking application.
